(19) United States
(12) Patent Application Publication
(10) Pub. No.: US 2013/0299730 A1
(43) Pub. Date: Nov. 14, 2013

(54) VALVE SEAT FOR A BALL VALVE

(71) Applicants: Andrew Spencer Nicholson, Barnstaple (GB); Matthew Hills, Barnstaple (GB)

(72) Inventors: Matthew Hills, Barnstaple (GB); Andrew Spencer Nicholson, Barnstaple (GB)

(21) Appl. No.: 13/883,651

(22) PCT Filed: Nov. 4, 2011
(86) PCT No.: PCT/GB2011/052142

§ 371 Date: Jul. 18, 2013

(30) Foreign Application Priority Data
Nov. 4, 2010 (GB) 1018616.1

(51) Int. Cl. F16K 5/20

(52) U.S. Cl. CPC F16K 5/20
USPC 251/315.01; 251/314

(57) ABSTRACT

A valve seat (30) for a ball valve (1) includes an annular body having a central aperture (36) defining a longitudinal flow channel, a first seating surface (38) for engaging and sealing against a corresponding portion of a fluid conduit and a longitudinally opposed second seating (40) surface for engagement with a valve ball. The first seating surface comprises a convex surface profile. The convex profile of the seat (30) allows the stresses incurred during loading from the valve ball (1) to be widely and evenly distributed throughout the structure of the seat (30).

The present invention relates to a valve seat for a ball valve.

Ball valves are straight-through flow valves in which the barrier to flow is a ball which is rotated 90 degrees to the direction of flow. Ball valves are commonly used to provide positive shutoff with minimal pressure drop and flow turbulence. In order to prevent fluid flow past the valve ball in the closed position, a valve seat is required to provide a sealing interface between the valve ball and the bore of the fluid channel within which it is located.

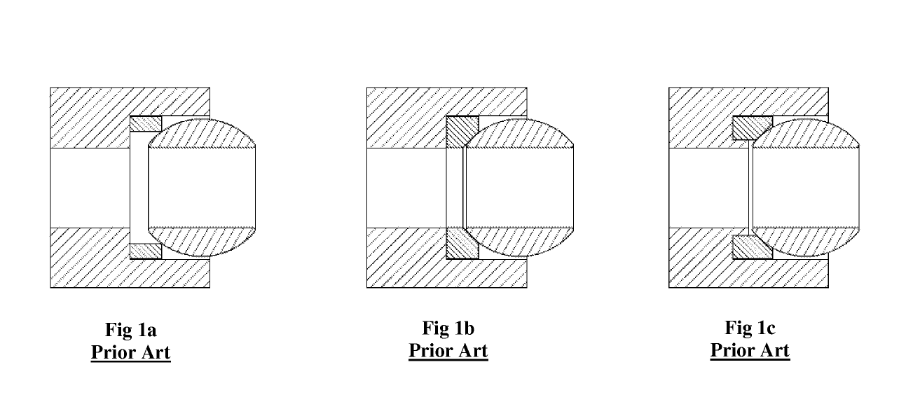

A ball valve seat comprises a first side which locates against a shoulder or other locating element within a flow channel with which the valve is associated, and a second side which engages with the valve ball. FIG. 1a shows a common valve seat arrangement, wherein the valve seat comprises a square edged ring, the flat outer face of which seals against a shoulder section and is sandwiched by the ball. The point contact between the inner corner of the valve seat and the ball lead to large stresses being created in the valve seat, leading to failure of the seal.

A variation on this arrangement is show in FIG. 1b, in which an angled inner surface is provided to reduce the stress contact region with the valve ball. This later design forms the basis for many of the valve seats manufactured today. A problem with this second design is that the initial external load placed upon the seat to achieve sealing often exceeds the capabilities of the seat material. This leads to cold flow of the material, which in turn leads to a change in the form of the seat. These changes in the seat form, away from that of its original design, may lead to a reduction in ability to seal at elevated pressures and reduced cycle life.

The above problems may be addressed by employing materials which have been modified to contain elements such as glass fibre. However, the inclusion of these elements can lead to a further set of problems such as causing damage to the ball due to their abrasive nature, increasing the internal stresses within the seat as a result of their ability to resist deformation, as well as a range of manufacturing issues.

An alternative solution to the problem of cold flow is to provide a rigid support structure around the seat. In the arrangement shown in FIG. 1c a recess is provided in the main body of the valve which is configured to receive and retain the valve seat. The recess supports the seat on all faces other than the valve engaging inner surface. However, such arrangements are more complex and hence more expensive to manufacture.

It is therefore desirable to provide an improved valve seat for a ball valve which addresses the above described problems and/or which offers improvements generally.

According to the present invention there is provided a valve seat for a ball valve as described in the accompanying claims.

In an embodiment of the invention there is provided a valve seat for a ball valve. The valve seat comprises an annular body having a central aperture defining a longitudinal flow channel; a first seating surface for engaging and sealing against a corresponding portion of a fluid conduit; and a longitudinally opposed second seating surface for engagement with a valve ball. The first seating surface comprises a convex surface profile.

The convex profile of the seat allows the stresses incurred during loading from the valve ball to be widely and evenly distributed throughout the structure of the seat. This is in contrast to more conventional designs which incorporate geometry that tends towards regions of concentrated stress levels while, at the same time, leaving other zones inactive and seemingly redundant.

The valve seat is preferably retained within a valve body, and the ‘corresponding portion of a fluid conduit’ referred to above may comprise a retaining shoulder or other retaining element provided within the valve body within which the valve seat is retained. Alternatively, the corresponding retaining portion may comprise any element which engages and retains the valve seat within the flow channel such that it is able to cooperate with the valve ball and the retaining portion to seal the flow channel.

The first seating surface preferably curves continuously from its radially outermost edge to its radially innermost edge. This continuous curve avoids geometries such as sharp angled edges or corners, or other configurations which act as formation sites for stress concentrations which can lead to damage or failure of the valve seat.

The first seating surface preferably curves longitudinally inwardly towards the second seating surface in a radially inward direction. In this way the convex surface profile of the first seating surface defines a region of the first seating surface which is longitudinally spaced from the corresponding portion of the fluid conduit against which it seats and is retained at a point radically inward of the contact point between two components. A cantilever arrangement is thereby defined which permits the valve seat to flex under loading rather than and without plastically deforming. This allows the seat the ability to be used in conditions where the ability to respond to fluctuations in process conditions is vital.

The surface profile of the first seating surface is preferably convex in the radial direction. The second seating surface may comprise a convex surface profile. This configuration permits rolling engagement between the valve ball and the second seating surface. This, combined with the inherent static stress distribution properties of the curved configuration, advantageously allows the stresses incurred during interaction with the valve ball to be widely and evenly distributed throughout the structure of the seat. In addition, the rolling engagement has been found to provide immediate sealing the instant the valve ball is placed under pressure loading from the fluid. Therefore, preloading of the valve ball against the valve seat which leads to early stress formation and pre-loading cold flow in arrangements of the prior art, is not required.

The second seating surface preferably curves continuously from its radially outermost edge to its radially innermost edge. This is in contrast to more conventional designs which incorporate geometry that tends towards regions of concentrated stress levels while, at the same time, leaving other zones inactive and seemingly redundant.

The second seating surface preferably curves longitudinally inwardly towards the first seating surface in a radially inward direction.

The surface profile of the second seating surface is convex in the radial direction.

The valve seat may further comprise a radially outer surface having a convex surface profile. The radially outer surface comprises a front edge which is common with the radially outermost edge of the first seating surface and a rear edge which is common with the radially outermost edge of the second seating surface, the outer surface curving continuously from the front edge to the rear edge.

The outer surface curves radially inwards from the front edge to the rear edge in the longitudinal direction. The outer seating surface and the first and second seating surfaces are arranged such that they define and provide the seat with a substantially triangular cross sectional shape taken in the longitudinal direction, the triangular cross section having convex sides. This cross-sectional shape firstly ensures that stresses created ball the valve ball/seat interaction are directed into the valve seat in a common single direction. In addition, the shape is such that once passed into the valve seat the stresses reflect within the seat and do not form at a point, thereby preventing the creation of stress risers.

The valve seat may be formed from a resilient material. Preferably the valve seat is formed from a polymeric thermoplastic.

The second seating surface extends over a greater longitudinal distance than first seating surface and has a shallower angle of incline relative to the central longitudinal axis of the seat. This arrangement causes the second seating surface to engage the valve ball at a position radially inwards of the engagement point between the first sealing surface and the fluid conduit such that a lever arm is defined between the first and second engagement points. This configuration results in the distal inner edge of the first seating surface being flexed in the longitudinal direction under loading from the valve ball.

The first seating surface is longitudinally outwardly facing and the second sealing surface is longitudinally inwardly facing relative to the valve ball, the valve seat being configured such that engagement of the valve ball with the second sealing surface causes at least a portion of the valve seat to move outwardly in the longitudinal direction.

In another aspect of the invention there is provided a ball valve including a ball valve seat as described above. The ball valve may comprise a valve body including a ball receiving cavity and at least one valve seat retaining portion.

The present invention will now be described by way of example only with reference to the following illustrative figures in which:

FIGS. 1a to 1c show diagrammatic representations of prior art ball valve seat arrangements;

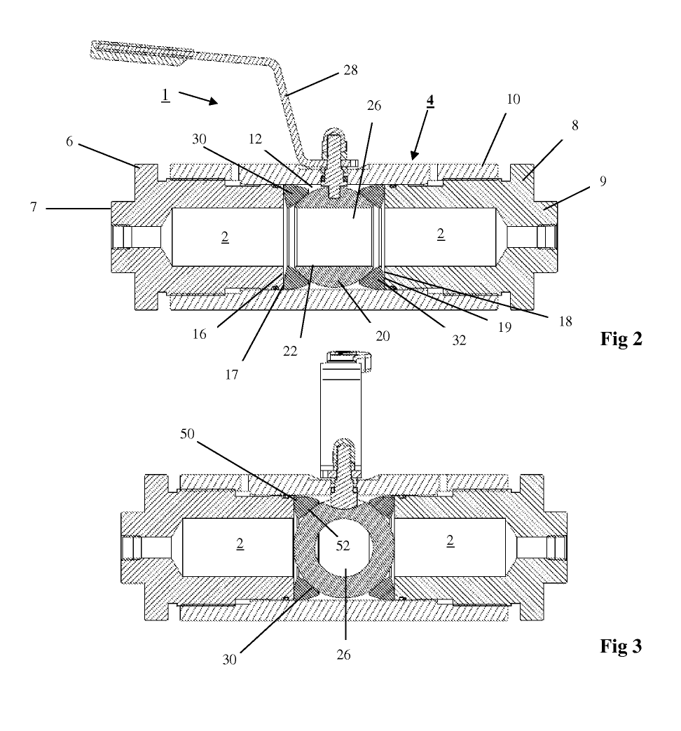

FIG. 2 shows cross sectional view of a ball valve according to an embodiment of the invention in the open position;

FIG. 3 shows cross sectional view of a ball valve of FIG. 2 in the closed position;

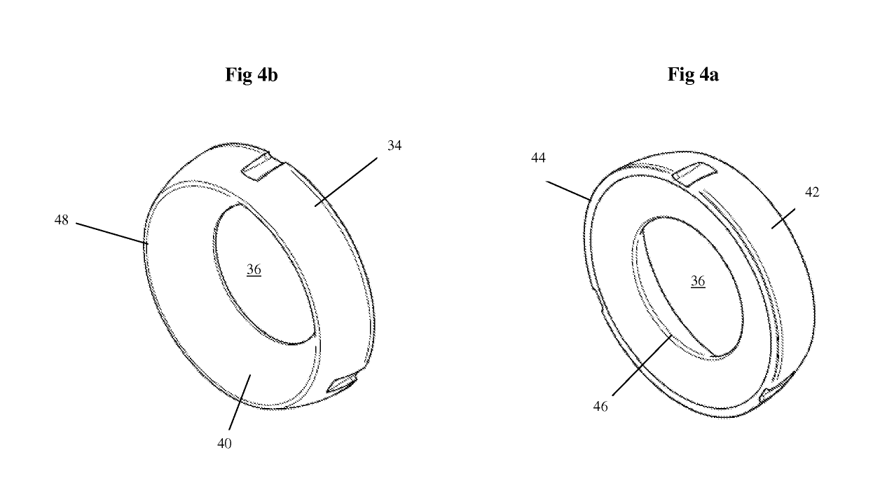

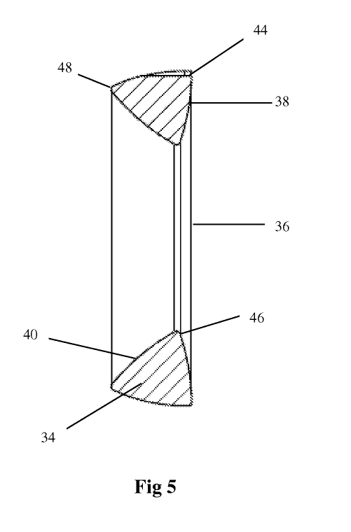

FIGS. 4a and 4b show isometric views of the ball valve associated with the ball valve of FIGS. 2 and 3 from the front and rear respectively; and

FIG. 5 shows cross sectional view of the ball valve seat of FIGS. 4a and 4b.

Referring to FIG. 2, a ball valve 1 is provided to selectively block fluid flow through a flow channel 2. The ball valve 1 comprises a valve body 4 including inner body elements 6 and 8 and an outer sleeve portion 10. The inner body elements include connection portions 7 and 9 respectively for connecting either end of the valve 1 to respective connecting portions of a fluid conduit within which the valve 1 is inserted. The inner body elements 6 and 8 are received within the outer sleeve section 10 and are held in position within the outer sleeve 10 by a threaded connection or any other suitable releasable connection means.

A valve ball housing chamber 12 is defined by the outer sleeve 10 and the opposing inner ends 16 and 18 of the inner body elements 6 and 8 respectively. The valve ball 20 is received and retained within the valve ball housing 12. The valve ball 20 comprises a bore 22 extending entirely through the centre thereof to define a longitudinal flow channel section 26. The flow channel section 26 is preferably of the same diameter as the flow channel 2 defined by the inner body sections 6 and 8, which is in open fluid connection with the valve ball housing chamber 12.

The valve ball 20 is connected to an actuating handle 28 via a spindle 30 which is rotatably mounted to the outer sleeve section 10. The ball valve 20 is rotationally fixed relative to the spindle 30, such that rotation of the spindle 30 by the handle 28 causes rotation of the ball 20 within the valve ball housing. The valve ball 20 is rotatable between an open position in which the bore 22 is aligned with the flow channel 2 to permit fluid flow through the channel 2 via the channel portion 26, and a closed position in which the bore 22 is oriented substantially perpendicular to the flow channel 2 such that fluid flow through the channel 2 is blocked by the valve ball 20.

To prevent fluid from passing between the valve body 4 and the valve ball 20 in the closed position, a pair of valve seats 30 and 32 is provided to create a sealed interface between the valve ball 20 and the valve body 4 on opposing sides of the valve ball 20. The following description sets out the features of the valve seat 30, but it will be appreciated that this description also applies to the valve seat 32 as the valve seats 30 and 32 are identical and merely oriented in opposing longitudinal directions on opposing sides of the valve ball 20.

The valve seat 30 comprises a substantially ring shaped annular body 34, as can be seen in FIGS. 4a and 4b. The valve seat 30 is preferably formed from polymeric thermoplastic. The valve seat 30 includes a central aperture 36, which defines a longitudinal fluid channel which aligns and is coaxial with the fluid channel 2 when installed within the valve body 4. The valve seat 30 includes an outwardly facing front surface 38, an inwardly facing rear surface 40 and a radially outer surface 42. The valve seat 30 is located between the valve ball 20 and the inner end 18 of the inner body element 6. The wall thickness of the inner body member 6 at the inner end 18 defines a shoulder to locate and retain the valve seat 30.

The fluid channel 2 has a longitudinal axis defined along its length which is coaxial with the longitudinal axis of the valve seat 30, and the term longitudinal direction as used herein may also be taken as meaning the axial direction of fluid flow. The front surface 38 of the valve seat 30, which is the surface which faces longitudinally away from the valve ball 20, engages and seats against the retaining shoulder 17 defined by the inner end 16 of the inner body member 6 to create a first sealing contact point 50. The longitudinally opposing rear surface 40 faces longitudinally inwardly and engages with the valve ball 20 to create a second sealing contact point 52. The radially outer surface 34 engages with the outer sleeve 10 to locate the valve seat 30 in the radial direction within the valve seat housing 12 transversely to the longitudinal axis.

The longitudinally outer front surface 38 comprises a circular outer edge 44 at its radially outer periphery, and an inner edge 46 which defines the aperture 36. As can be seen in FIG. 5, the front surface 38 has a convexly curved surface profile in the radial direction. The convexly curved surface profile of the front surface 38 extends and curves continuously between the outer edge 44 and the inner edge 46. The curved profile extends inwardly from a longitudinally outermost point which is coterminous with the outer edge 44, to a longitudinally innermost point coterminous with the inner edge 46.

The longitudinally outermost point of the front surface 38 contacts the inner end 17 of the inner body member 6 to create and define the first sealing contact point 50. The inner end 17 comprises a flat annular face oriented substantially transverse to the longitudinal axis, and hence perpendicular to the outer sleeve 10. The front surface 38 of the valve seat 30 curves longitudinally inwardly away from the inner end 17 from the sealing contact point 50 towards the rear surface 40, with the inner edge 46 being spaced longitudinally inwardly of the inner end 17. In this way a cantilever is defined between the contact point 50 and the inner edge 46.

The rear surface 40 also comprises a convex surface profile. The convex curved profile extends continuously between the inner edge 46 and the outer edge 48 of the rear surface 40. The longitudinal distance between the inner edge 46 and the outer edge 48 is greater than the longitudinal distance between the inner edge 46 and the outer edge 44 of the front surface 38. In addition, the outer edge 48 of the rear surface 40 is located radially inwards of the outer edge 44. Therefore the sealing contact point 52 between the rear surface 40 and the valve ball 20 is positioned radially inwards of the sealing contact point 50 between the front face 38 and the inner edge 17.

In use, the ball valve 1 is assembled such that the valve ball 20 is in engagement with the valve seats 30 and 32 and such that the valve seats 30 and 32 are in engagement with the inner ends 17 and 19 respectively. The engagement between the valve seat 30 and the valve ball 20 is such that the valve ball 20 is able to rotate relative to the valve seat 20 between the open and closed positions. In the closed position, with the valve ball 20 blocking fluid flow through the channel 2, the fluid engages the valve ball from the direction of flow, and urges the ball 20 against the valve seat 30 or 32 on the opposing side of the valve ball 20. The cantilever arrangement defined by the radially offset sealing contact points is such that engagement of the valve ball 20 with the valve seat 30 at the contact point 52 creates a lever arm force which causes movement of the inner edge 46 in the longitudinal direction away from the ball 20, with the inner portion of the valve seat 30 pivoting about the contact point 50.

The cross sectional shape of the valve seat 30 allows it to flex under longitudinal loading from the valve ball 20 without plastically deforming. Specifically, the continuously curved convex outer surface profile of the front surface 38 removes formation sites for stress concentrators. This allows the seat 30 to be used in conditions where the ability to respond to fluctuations in process conditions is vital.

In addition, flexing of the valve seat 30 in the longitudinal direction causes the valve seat 30 to generate a biasing force in the opposing direction which acts against the valve ball 20. The forced loaded engagement between the valve ball 20 and the valve seat 30 leads to a significantly improved sealing engagement between the two components. As such, the valve seat 30 acts dynamically with the ball 20 to aid pressure retention, in contrast to the valve seats of the prior art which are passive seals that are immovably trapped between the valve ball and the end closures.

The convex curved profile of the rear surface 40 of the valve seat 30 permits rolling engagement between the valve ball 20 and the rear surface 40 which advantageously allows the stresses incurred during interaction with the valve ball 20 to be widely and evenly distributed throughout the structure of the seat 30. This is in contrast to more conventional designs which incorporate geometry that tends towards regions of concentrated stress levels while, at the same time, leaving other zones inactive and seemingly redundant. In addition, in systems of the prior art the valve ball is preloaded against the valve seat to ensure that an effective seal is created at the instant of fluid loading. This pre-loading creates early stresses in the valve seat, and leads to the initiation of cold flow even before the valve is placed under pressure loading from the fluid. In contrast, the rolling engagement of the present invention is such that an instant seal is created when fluid loading is initiated, thereby obviating the requirement for pre-loading of the valve ball.

The curved radially outermost surface 34 similarly assists in reducing stresses by providing an interface between the valves seat 30 and the inner wall of the valve body 4 in which stresses are evenly distributed to the valve seat 30 during radial interaction with the valve body 4 during loading.

As the valve seat 30 is 3 sided when viewed in cross section, and each of the sides are curved, three point contacts are therefore created between the valve seat 30 against the valve ball 20, the ends if the valve ball housing 16 and 18, and the inner bore of the inner wall of the valve housing 4. The point contact with the valve ball 20 significantly reduces the torque required to rotate the valve ball 20 when operating the valve 1, in contrast to the prior art arrangement in which a greater surface contact between the valve seat and valve ball leads to greater frictional contact and hence a greater torque requirement. As such, the present invention reduces the effort required to operate the valve, as well as reducing damage to the valve spindle due to excessive torque.

It will be appreciated that in further embodiments various modifications to the specific arrangements described above and shown in the drawings may be made. For example, reference to the valve seat being annular does not require the valve seat to be perfectly circular in shape, and merely requires the seat to have a continuous body portion having a central aperture passing therethrough, which is able to seal against a suitable correspondingly shaped ‘ball’. For example, the valve seat may be ellipsoid in shape, with the ball also having a corresponding ellipsoid shape configured to seal against the seat. In addition, while the valve seats are described for use with a fixed ball valve, they may also be applied in other arrangements such as a floating ball valve.

1. A valve seat for a ball valve, the valve seat comprising:
an annular body having a central aperture defining a longitudinal flow channel;
a first seating surface for engaging and sealing against a corresponding portion of a fluid conduit; and
a longitudinally opposed second seating surface for engagement with a valve ball;
wherein at least one of the first seating surface and the second seating surface comprises a convex surface profile.

2. A valve seat according to claim 1 wherein both first seating surface and the second seating surface comprise a convex surface profile.

3. A valve seat according to claim 1 wherein the first seating surface curves continuously from its radially outermost edge to its radially innermost edge.

4. A valve seat according to claim 1 wherein the first seating surface curves longitudinally inwardly towards the second seating surface in a radially inward direction.

5. A valve seat according to claim 1 wherein the surface profile of the at least one of the first seating surface and the second seating surface is convex in the radial direction.

6. A valve seat according to claim 1 wherein the second seating surface curves continuously from its radially outermost edge to its radially innermost edge.

7. A valve seat according to claim 1 wherein the second seating surface curves longitudinally inwardly towards the first seating surface in a radially inward direction.

8. A valve seat according to claim 1 further comprising a radially outer surface having a convex surface profile.

9. A valve seat according to claim 8 wherein the radially outer surface comprises a front edge which is common with the radially outermost edge of the first seating surface and a rear edge which is common with the radially outermost edge of the second seating surface, the outer surface curving continuously from the front edge to the rear edge.

10. A valve seat according to claim 9 wherein the outer surface curves radially inwards from the front edge to the rear edge in the longitudinal direction.

11. A valve seat according to claim 1 formed from a resilient material.

12. A valve seat according to claim 1 wherein the second seating surface extends a greater longitudinal distance than first seating surface.

13. A valve seat according to claim 1 wherein the first seating surface and second seating surface are configured such that the second seating surface engages the valve ball at a position radially inwards of the engagement point between the first sealing surface and the fluid conduit such that a lever arm is defined between the first and second engagement points.

14. A valve seat according to claim 13 wherein in use the first seating surface is longitudinally outwardly facing and the second sealing surface is longitudinally inwardly facing relative to the valve ball, the valve seat being configured such that engagement of the valve ball with the second sealing surface causes at least a portion of the valve seat to outwardly in the longitudinal direction.

15. A valve seat according to claim 1 comprising three surfaces defining a generally triangular cross-sectional shape in the longitudinal direction.

16. A ball valve comprising at least one valve seat according to claim 1.

17. A ball valve according to claim 16 comprising a valve body including a ball receiving cavity and at least one valve seat retaining portion.

18-19. (canceled)
